(19) United States
(12) Patent Application Publication
(10) Pub. No.: US 2025/0013937 A1
(43) Pub. Date: Jan. 9, 2025

(54) Holiday Modeling in Forecasting

(71) Applicant: Google LLC, Mountain View, CA (US)

(72) Inventors: Honglin Zheng, Seattle, WA (US); Haoming Chen, Kirkland, WA (US); Jun Ya Zhang, Kirkland, WA (US); Xi Cheng, Kirkland, WA (US); Weijie Shen, Mountain View, CA (US); Jiashang Liu, Kirkland, WA (US); Mingge Deng, Kirkland, WA (US); Amir Hossein Hormati, Seattle, WA (US)

(21) Appl. No.: 18/739,429

(22) Filed: Jun. 11, 2024

Related U.S. Application Data
(60) Provisional application No. 63/525,478, filed on Jul. 7, 2023.

(51) Int. Cl. G06Q 10/04; G06Q 10/1057

(52) U.S. Cl. CPC G06Q 10/04; G06Q 10/1057

(57) ABSTRACT

Aspects of the disclosure are directed methods, systems, and computer readable media for in-database holiday effect modeling for time series forecasting. The modeling can be accurate, explainable, customizable, and scalable. Machine learning models can receive a first dataset for time series data and a second dataset for configurable holiday data. The models can detect and model effects of each configurable holiday on one or more forecasts, effectively accumulating effects of overlapping holidays, to manage different levels of holiday modeling. Holiday data can be customizable, including an ability to modify existing holidays and/or add new holidays, through one or more interfaces that can display default holiday information, combined holiday information based on both default and customizable holidays, effects of each holiday on forecasts, and accumulated effects of multiple holidays on forecasts.

### CROSS-REFERENCE TO RELATED APPLICATIONS

The present application claims the benefit of the filing date of U.S. Provisional Patent Application No. 63/525,478, filed Jul. 7, 2023, the disclosure of which is hereby incorporated herein by reference.

### BACKGROUND

Forecasting future trends based on historical data can provide useful information for a multitude of different applications. The need for accurate forecasting of future trends has grown as vast amounts of data become readily available and users seek to leverage accurate forecasts to gain competitive advantages. When forecasting future data trends, several underlying components may impact variations in data, leading to difficulties in accurate forecasting. One such component is holiday or special event modeling support, which can be critical in achieving accurate forecasting results. Many machine learning models aiming to accurately forecast future trends incorporate a time component but have limited holiday or special event modeling support. Incorporating holiday or special event modeling support can be challenging due to the numerous additional factors for the machine learning models to consider based on the potential uniqueness of holidays or special events per user.

### BRIEF SUMMARY

Aspects of the disclosure are directed methods, systems, and computer readable media for in-database holiday effect modeling for time series forecasting. The modeling can be accurate, explainable, customizable, and scalable. As examples, holidays may refer to religious holidays, regional holidays, special events, or any significant day particular to one or more users. Machine learning models can receive at least two datasets, including a first dataset for time series data and a second dataset for configurable holiday data. The models can detect and model effects of each configurable holiday on one or more forecasts, accumulating effects of overlapping holidays, to manage different levels of holiday modeling. Different levels may refer to global, national, regional, local, per company, and/or per user, as examples. Holiday data can be customizable, including an ability to modify existing holidays or add new holidays, through one or more interfaces that can display default holiday information, combined holiday information based on both default and customizable holidays, effects of each holiday on forecasts, and accumulated effects of multiple holidays on forecasts.

An aspect of the disclosure provides for a method for time series forecasting including: receiving, with one or more processors, a request to perform a forecast on time series data, the time series data including data associated with configurable holiday information; generating, with the one or more processors, deholidayed series data from the time series data; determining, with the one or more processors, one or more holiday effects for the data associated with the configurable holiday information based on a difference between the deholidayed series data and the time series data; generating, with the one or more processors, one or more models for performing the forecast based on the holiday effects; and performing, with the one or more processors, the forecast on the time series data using the one or more models.

Another aspect of the disclosure provides for a system including: one or more processors; and one or more storage devices coupled to the one or more processors and storing instructions that, when executed by the one or more processors, cause the one or more processors to perform operations for the method for time series forecasting. Yet another aspect of the disclosure provides for a non-transitory computer readable medium for storing instructions that, when executed by one or more processors, cause the one or more processors to perform operations for the method for time series forecasting.

In an example, configurable holiday information includes at least one of unique holidays or holidays specific to one or more regions. In another example, the method further includes verifying, with the one or more processors, the forecast using a public table or table valued function. In yet another example, generating the one or more models further includes training the one or more models to account for the holiday effects when performing forecasts.

In yet another example, generating the one or more models further includes selecting a model of the one or more models to perform the forecast. In yet another example, generating the deholidayed series data further includes setting days in a holiday impact window as missing values in the time series data. In yet another example, the holiday impact window includes a day before a holiday, one or more days of a holiday, and a day after the holiday. In yet another example, generating the deholidayed series data further includes employing loss interpolation on the missing values in the time series data. In yet another example, determining one or more holiday effects further includes determining, for each holiday impact window in the time series data, whether a difference between the deholidayed series data and the time series data is greater than a threshold. In yet another example, determining one or more holiday effects further includes performing at least one of loss smoothing or double exponential smoothing for each holiday impact window where the difference between the deholidayed series data and the time series data is greater than the threshold.

### BRIEF DESCRIPTION OF THE DRAWINGS

FIG. 1 depicts a block diagram of an example time series forecasting system according to aspects of the disclosure.

FIG. 2 depicts a block diagram of an example environment for implementing a time series forecasting system according to aspects of the disclosure.

FIG. 3 depicts a block diagram illustrating one or more model architectures according to aspects of the disclosure.

FIG. 4 depicts a block diagram of an example pipeline for forecasting according to aspects of the disclosure.

FIG. 5 depicts a flow diagram of an example process for performing time series forecasting according to aspects of the disclosure.

### DETAILED DESCRIPTION

A time series is a series of data points in chronological sequence, such as in regular intervals. Analysis on a time series may be applied to any variable that changes over time, such as industrial processes or business metrics. Time series forecasting may refer to predicting or extrapolating future data values based on past data values. Time series forecasting has become a significant domain for machine learning. In machine learning, a model is trained until the model provides satisfactory results. The model is then used to make predictions on new data for a period of time until there is sufficient enough new data to warrant retraining the model with the additional new data. However, with time series forecasting, retraining the model may be necessary when even a single new data point is received. Deploying static machine learning models can be ineffective for time series forecasting.

To account for this, a time series forecasting system can forecast numerous time series in parallel based on receiving a query. The system can receive a time series forecasting request for a plurality of time series forecasts. For each of the plurality of time series forecasts, the system can train a plurality of models and determine which model best fits the respective time series forecast. The system can forecast future data based on each of the determined best fitting models and return the forecasted future data for each requested time series forecast as a query response.

Holidays can be a crucial factor in time series forecasting. Industries, such as retail, telecommunications, entertainment, and/or manufacturing, heavily rely on holiday data to forecast inventory, sales revenue, or effectiveness of certain marketing events. Holiday modeling in time series forecasting can specify a static holiday configuration and forecast a holiday effect using the static holiday configuration. However, the static holiday configuration is not transparent and prevents customization of holidays, leading to difficulties in evaluating the effectiveness of incorporating customizable holidays in time series forecasting.

To account for this, the technology generally relates to holiday modeling in time series forecasting, allowing for customizing holiday data to improve time series forecasting accuracy. The static holiday configuration can specify one or more regions where holiday effects can be applied. In order to obtain information about holidays in the specified regions, the time series forecasting can provide for an interface. Through this interface, the time series forecasting can receive queries and provide holiday information for the specified regions. The provided holiday information is retrieved and stored to a new public table associated with holidays and events for forecasting. The interface can receive a query for the public table before generating the forecasting model or input the generated forecast model with a new table valued function that includes data associated with particular holidays or events. The query response can return a table of holidays and other relevant information, such as a primary date and a time window, demonstrating how holidays are being modeled by the time series forecasting.

Each individual holiday can have its own holiday effect. The model can also provide an interface for holiday effects by observing the weight of each holiday, which contributes to the actual forecasted value. The interface can input a generated forecast model with a current table valued function to return a table with its own column of each holiday and annotating the contribution of each holiday to the overall forecast result. In addition to a timestamp, the time series data, and/or standard error, the result table can include a series of additional columns indicating the contribution of individual holidays.

The holiday data can be customized according to the preferences through an interface, enabling the generation of forecast modeling based on the customized holiday data. To generate a model using customized holidays, the custom holiday data source can be defined via queries. The queries can have the same schema of the public table and include attributes such as region, holiday name, primary date, pre-holiday days, and/or post-holiday days. The interface provides the custom holiday table by modifying the query syntax through the interface. The interface provides flexibility to generate a new customized holiday configuration or add holidays to or remove holidays from the static holiday configuration, which can be used to generate models for forecasting.

By combining with the static holiday configuration, the time series forecasting can support one or more of the following scenarios: overwriting one or more holidays of the static holiday configuration, such as revising a primary date or adjusting a holiday effect window of time; supplementing the static holiday configuration with additional custom holidays; or forecasting based only on a customized holiday configuration.

The time series forecasting can account for the customized holiday configurations and the effects of each holiday on the forecast. The time series forecasting can receive time series data and can set days within a holiday impact window as missing values. Days within a holiday impact window can include the day before the holiday, the holiday itself, and the day after the holiday, as an example. To fill in these missing values, the time series forecasting can employ loss interpolation techniques to generate deholidayed series data, which can also account for any seasonal patterns in the data.

The time series forecasting can calculate a holiday effect for a particular holiday by taking the difference between time series data and the deholidayed series data. The time series forecasting can verify the significance for each holiday, as not all holidays may have a meaningful impact on the forecast. A holiday can be significant if the difference between the time series data and the deholiday series data is greater than a threshold. The threshold can be based on year to year variation of the time series data. For each holiday determined to be significant, the time series of its respective holiday effects is taken over time and is processed by loss interpolation techniques to achieve smoothness. The time series forecasting can employ double exponential smoothing techniques to generate forecasted holiday effects for future holidays.

The time series forecasting enables forecasting of holiday effects for future holidays and accumulating effects of overlapping holidays. Additionally, the time series forecasting can handle holiday modeling for different geographical levels such as global, continental, national, and regional.

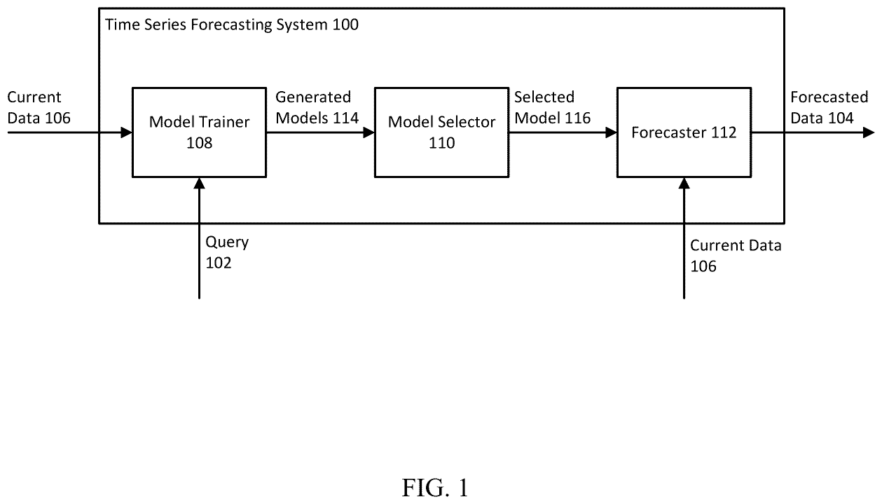

FIG. 1 depicts a block diagram of an example time series forecasting system 100. The time series forecasting system 100 may be part of a remote system in communication with one or more user devices via a network. The remote system may be a single computer, multiple computers, or a distributed system like a cloud environment. The remote system may include computing resources, such as data processing hardware, and storage resources, such as memory hardware. A data store, such as a remote storage device, may be overlain on the storage resources to allow scalable use of the storage resources by one or more of the clients, such as the user devices, or the computing resources. The data store can be configured to store a plurality of data blocks within one or more tables, such as a cloud database, that each include a plurality of rows and columns. The data store may store any number of tables at any point in time.

The time series forecasting system 100 can be configured to receive a time series forecasting query 102, such as from a user device via the network. The user device may correspond to any computing device, such as a desktop workstation, a laptop workstation, or a mobile device, such as a smartphone. The user device can include computing resources and storage resources. The query may be natural language or standard query language (SQL). Each time series forecasting query 102 can request one or more time series forecasts for the time series forecasting system 100 to generate a forecast of future data 104 based on current data 106. The time series forecasting system 100 can forecast and return forecasted future data 104, such as to the user device via the network as a query response.

The time series forecasting system 100 can include model trainer 108, a model selector 110, and a forecaster 112. The model trainer 108 can be configured to generate and train a plurality of forecasting models 114 for each forecast request in the query 102. The model trainer 108 can train the forecasting models 114 on current data 106, such as data blocks retrieved from one or more tables stored on the data store associated with the requested time series forecasts. The current data 106 can include configurable holiday information, such as holiday information received from a user device and unique to the user device. The current data 106 can further include a public dataset of holiday information, which can be overwritten and/or supplemented with holidays. The query 102 may also include the current data 106, such as the current data 106 being provided from the user device via the network.

The model trainer 108 can be configured to generate and/or train each model 114 with different parameters. For example, the model trainer 108 can generate and train a plurality of autoregressive integrated moving average (ARIMA) models with different orders of the autoregressive models, such as the number of time lags, different degrees of differencing, such as the number of times the data has had past values subtracted, and/or an order of the moving average model, such as a size of the moving average window. Using a combination of different parameters, the model trainer 108 can generate a corresponding forecasting model 114 for each combination. Each model 114 can be trained using the same data 106 with one or more of the parameters being configurable or partially configurable, such as by a user device.

The model trainer 108 can be configured to perform hyper-parameter tuning or optimization when generating and training the plurality of models 114. A hyper-parameter may refer to a parameter that controls or adjusts learning process of the models 114 while other parameters, such as node weights, are learned. For example, the model trainer 108 can perform hyper-parameter tuning on a data frequency and non-seasonal order parameters. The model trainer 108 can generate and train forecasting models 114 capable of modeling different aspects of time series, such as seasonal effects, holiday effects, modeling drift, and/or anomalies.

The model selector 110 can be configured to receive each trained model 114 to determine which model 116 of the models 114 best fits the data 106. Machine learning models can be trained on a training dataset and then evaluated on a test dataset but, because time series data can be a limited dataset, the time series forecasting system 100 may use the same data to both train and evaluate the models 114. For example, the model selector 110 can determine which model 114 results in a lowest Akaike information criterion (AIC). The AIC may refer to an estimator of out-of-sample prediction error and thus may represent a relative quality of a corresponding model relative to each other model trained on the same data 106. The model selector 110 can select the best fitting model 116, such as the model with the lowest AIC, and can send the selected model 116 to the forecaster 112.

The forecaster 112 can be configured to use the selected model 116 to forecast future data 104 based on the current data 106. The forecaster 112 can return the forecasted future data 104 to the user device, which can display the forecasted data 104, such as via a graph. Each time series requested by the query 102 can be displayed on the graph with configurable filters for controlling which portions of which time series are displayed. For example, the query 102 can include a request for ten time series forecasts. After receiving the future data 104, the user device can display on a graph with all ten time series forecasts simultaneously. The display can be adjusted on the user device to change which times series are viewable, as well as zoom in or zoom out on the graph as desired.

As an example, the query 102 can include ten time series forecasts and the model trainer 108 can train forty models 114 per time series forecast, such that the model trainer 108 generates and trains four hundred models 114 simultaneously. The time series forecasting system 100 may replicate the model trainer 108 for each time series forecast, e.g., ten replications of the model trainer 108 for ten forecast requests requested by the query 102. The model selector 110 determines the best fitting model 116 for the corresponding forecast request from each set of models 114 simultaneously, such as via replication. The forecaster 112 may also forecast the future data 104 based on multiple selected models 116 simultaneously, such as via replication. The forecasted future data 104 from each of the selected models 116 may be included within a query response that is returned to the user device. Thus, by receiving a query 102 requesting a plurality of time series forecasts, and the time series forecasting system 100 can process each of the time series forecasts in parallel, greatly reducing the amount of time required to respond to the query 102.

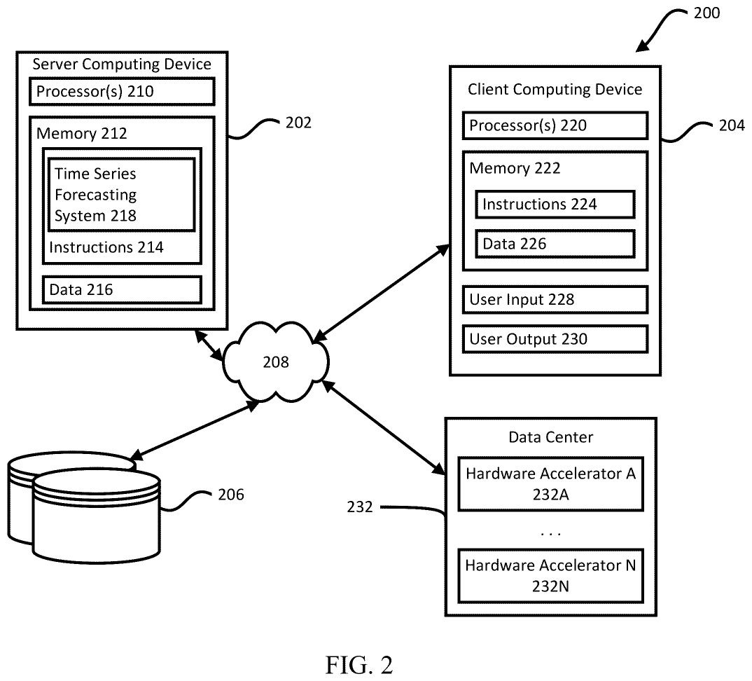

FIG. 2 depicts a block diagram of an example environment 200 for implementing a time series forecasting system 218. The time series forecasting system 218 can be implemented on one or more devices having one or more processors in one or more locations, such as in server computing device 202. Client computing device 204 and the server computing device 202 can be communicatively coupled to one or more storage devices 206 over a network 208. The storage devices 206 can be a combination of volatile and non-volatile memory and can be at the same or different physical locations than the computing devices 202, 204. For example, the storage devices 206 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 202 can include one or more processors 210 and memory 212. The memory 212 can store information accessible by the processors 210, including instructions 214 that can be executed by the processors 210. The memory 212 can also include data 216 that can be retrieved, manipulated, or stored by the processors 210. The memory 212 can be a type of non-transitory computer readable medium capable of storing information accessible by the processors 210, such as volatile and non-volatile memory. The processors 210 can include one or more central processing units (CPUs), graphic processing units (GPUs), field-programmable gate arrays (FPGAs), and/or application-specific integrated circuits (ASICs), such as tensor processing units (TPUs).

The instructions 214 can include one or more instructions that, when executed by the processors 210, cause the one or more processors to perform actions defined by the instructions 214. The instructions 214 can be stored in object code format for direct processing by the processors 210, or in other formats including interpretable scripts or collections of independent source code modules that are interpreted on demand or compiled in advance. The instructions 214 can include instructions for implementing a time series forecasting system 218, which can correspond to the time series forecasting system 100 of FIG. 1. The time series forecasting system 218 can be executed using the processors 210, and/or using other processors remotely located from the server computing device 202.

The data 216 can be retrieved, stored, or modified by the processors 210 in accordance with the instructions 214. The data 216 can be stored in computer registers, in a relational or non-relational database as a table having a plurality of different fields and records, or as JSON, YAML, proto, or XML documents. The data 216 can also be formatted in a computer-readable format such as, but not limited to, binary values, ASCII, or Unicode. Moreover, the data 216 can include information sufficient to identify relevant information, such as numbers, descriptive text, proprietary codes, pointers, references to data stored in other memories, including other network locations, or information that is used by a function to calculate relevant data.

The client computing device 204 can also be configured similarly to the server computing device 202, with one or more processors 220, memory 222, instructions 224, and data 226. The client computing device 204 can also include a user input 228 and a user output 230. The user input 228 can include any appropriate mechanism or technique for receiving input from a user, such as keyboard, mouse, mechanical actuators, soft actuators, touchscreens, microphones, and sensors.

The server computing device 202 can be configured to transmit data to the client computing device 204, and the client computing device 204 can be configured to display at least a portion of the received data on a display implemented as part of the user output 230. The user output 230 can also be used for displaying an interface between the client computing device 204 and the server computing device 202. The user output 230 can alternatively or additionally include one or more speakers, transducers or other audio outputs, a haptic interface or other tactile feedback that provides non-visual and non-audible information to the platform user of the client computing device 204.

Although FIG. 2 illustrates the processors 210, 220 and the memories 212, 222 as being within the computing devices 202, 204, components described herein can include multiple processors and memories that can operate in different physical locations and not within the same computing device. For example, some of the instructions 214, 224 and the data 216, 226 can be stored on a removable SD card and others within a read-only computer chip. Some or all of the instructions and data can be stored in a location physically remote from, yet still accessible by, the processors 210, 220. Similarly, the processors 210, 220 can include a collection of processors that can perform concurrent and/or sequential operation. The computing devices 202, 204 can each include one or more internal clocks providing timing information, which can be used for time measurement for operations and programs run by the computing devices 202, 204.

The server computing device 202 can be connected over the network 208 to a data center 232 housing any number of hardware accelerators 232A-N. The data center 232 can be one of multiple data centers or other facilities in which various types of computing devices, such as hardware accelerators, are located. Computing resources housed in the data center 232 can be specified for deploying models related to time series forecasting as described herein.

The server computing device 202 can be configured to receive requests to process data from the client computing device 204 on computing resources in the data center 232. For example, the environment 200 can be part of a computing platform configured to provide a variety of services to users, through various user interfaces and/or application programming interfaces (APIs) exposing the platform services. The variety of services can include performing time series forecasting. The client computing device 204 can transmit input data associated with requests for forecasts. The time series forecasting system 218 can receive the input data, and in response, generate output data including a forecast.

As other examples of potential services provided by a platform implementing the environment 200, the server computing device 202 can maintain a variety of models in accordance with different constraints available at the data center 232. For example, the server computing device 202 can maintain different families for deploying models on various types of TPUs and/or GPUs housed in the data center 232 or otherwise available for processing.

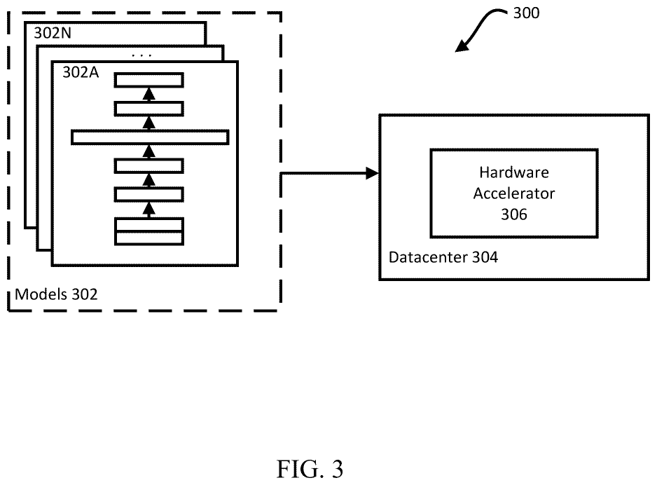

FIG. 3 depicts a block diagram 300 illustrating one or more model architectures 302, more specifically 302A-N for each architecture, for deployment in a data center 304 housing a hardware accelerator 306 on which the deployed models 302 will execute for providing forecasts. The hardware accelerator 306 can be any type of processor, such as a CPU, GPU, FPGA, or ASIC such as a TPU.

An architecture 302 of a model can refer to characteristics defining the model, such as characteristics of layers for the model, how the layers process input, or how the layers interact with one another. For example, the one or more models can be autoregressive integrated moving average (ARIMA) models, and the one or more model architectures 302 may refer to different orders of the autoregressive models, such as the number of time lags, different degrees of differencing, such as the number of times the data has had past values subtracted, and/or an order of the moving average model, such as a size of the moving average window. One or more model architectures 302 can be generated that can output results associated with forecasts.

Referring back to FIG. 2, the devices 202, 204 and the data center 232 can be capable of direct and indirect communication over the network 208. For example, using a network socket, the client computing device 204 can connect to a service operating in the data center 232 through an Internet protocol. The devices 202, 204 can set up listening sockets that may accept an initiating connection for sending and receiving information. The network 208 itself can include various configurations and protocols including the Internet, World Wide Web, intranets, virtual private networks, wide area networks, local networks, and private networks using communication protocols proprietary to one or more companies. The network 208 can support a variety of short- and long-range connections. The short- and long-range connections may be made over different bandwidths, such as 2.402 GHz to 2.480 GHz, commonly associated with the Bluetooth® standard, 2.4 GHz and 5 GHZ, commonly associated with the Wi-Fi® communication protocol; or with a variety of communication standards, such as the LTE® standard for wireless broadband communication. The network 208, in addition or alternatively, can also support wired connections between the devices 202, 204 and the data center 232, including over various types of Ethernet connection.

Although a single server computing device 202, client computing device 204, and data center 232 are shown in FIG. 2, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

Referring back to FIG. 1, the query 102 can include a reference to one or more columns of a time series table stored in the data store associated with the current data 106. The one or more columns can include time series identification information, time series timestamp data, and the time series data itself. The time series timestamp column can include a time component of the time series. Each data element of the time series timestamp column can represent a point in time associated with a respective time series data element from the time series data column. The time series forecasting system 100 can use the time series timestamp data and time series data as the current data 106 to train the forecasting models 114 and to forecast the future data 104 using the selected model 116.

The query 102 can further include a reference to one or more columns of a holiday table stored in the data store associated with the current data 106. The one or more columns can include region, holiday name, primary days, pre-holiday days, and post-holiday days. The data in the one or more columns can be predetermined or user-configured. The region can refer to a geographic area that celebrates a particular holiday, e.g., country, state, or locality, the holiday name can refer to an identification of the holiday, e.g., Thanksgiving or Members Day respectively, the primary days can refer to the days of the holiday, the pre-holiday days can refer to days of significance before a holiday, e.g., 1 day before a holiday, and the post-holiday days can refer to days of significance after a holiday, e.g., 1 day after a holiday. The time series forecasting system 100 can use the data in the one or more columns of the holiday table as the current data 106 to train the forecasting models 114 and to forecast the future data 104 using the selected model 116.

The time series forecasting system 100 can output the forecasted data 104 for display as a plot illustrating the time series and corresponding components of the time series. The time series can include a series of data points with respect to time. The time series can be decomposed into a trend component, a seasonal component, and a remainder portion. The trend component can represent trends in the data that move up or down in a reasonably predictable pattern. The trend component can also include cyclical variations that correspond to cycles, such as “boom-bust” cycles. The seasonal component can represent variations that repeat over a specific period, such as over a day, week, month, etc. The remainder component can represent seemingly random residual fluctuations that do not fall under classifications of other components. The time series can further be decomposed into one or more holiday effects components, which can represent different effects per holiday on the forecasted data 104 as well as an overall holiday effect on the forecasted data 104. The overall holiday effect can correspond to a sum of maximum positive individual holiday effects and minimum negative individual holiday effects.

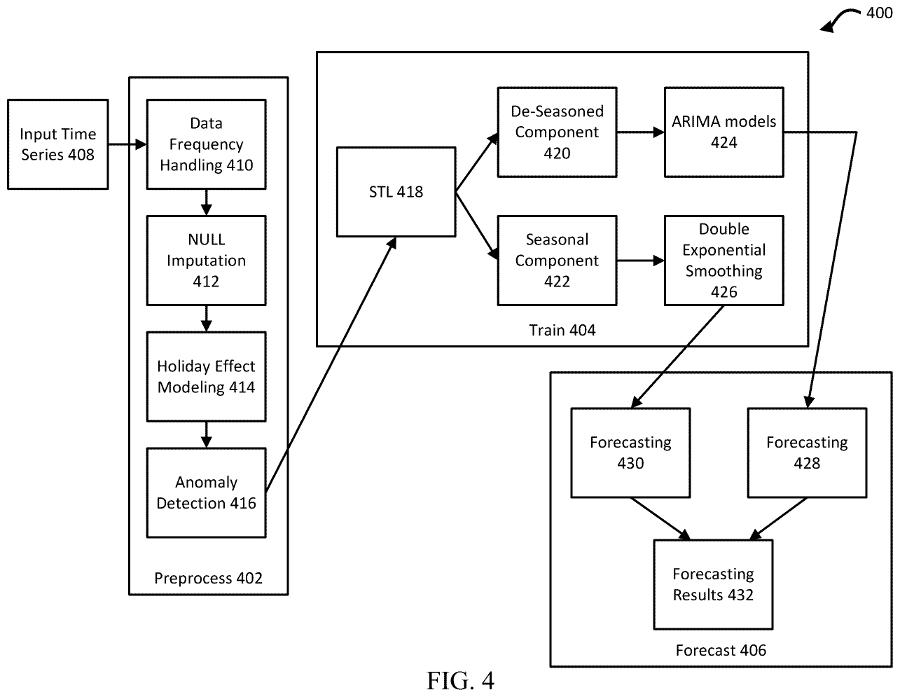

FIG. 4 depicts a block diagram of an example pipeline 400 for forecasting. The pipeline 400 can be performed on a system of one or more processors in one or more locations, such as the example time series forecasting system 100 as depicted in FIG. 1. The pipeline 400 can include three stages: preprocessing 402, training 404, and forecasting 406.

The preprocessing stage 402 can receive input time series 408, such as current data stored on a data store, and can perform data frequency handling 410, NULL imputation 412, holiday effect modeling 414, and/or anomaly detection 416 on the time series 408. Data frequency handling 410 may refer to receiving or determining a data frequency for the input time series data 408. The data frequency handling 410 may be received as a specific data frequency, e.g., daily, weekly, or monthly. The data frequency handling 410 may also be determined based on a median time interval from the input time series data 408. NULL imputation 412 may refer to determining and/or rejecting any nulls in the input time series 408. The holiday effect modeling 414 accounts for effects due to holidays that may otherwise be missed by seasonality modeling or mistakenly smoothed by anomaly detection 416. While shown with respect to preprocessing 402, the holiday effect modeling 414 may also be included in the training 404 as an addition or alternative. Anomaly detection 416 may refer to determining and/or removing outlier data from the input time series 402 that is not associated with holiday effects.

The holiday effect modeling 414 can be configured to set days in a holiday impact window as missing values. The holiday impact window can correspond to the day before a holiday, the holiday itself, and the day after the holiday, as an example. The holiday effect modeling 414 can employ loss interpolation to fill in the missing values and thus generate deholidayed series data. The holiday effect modeling 414 can be configured to take the difference between the time series data 408 and the deholidayed series data as the holiday effect for a particular holiday. The holiday effect modeling 414 can be configured to test the significance for the holiday, as not all holidays may have a meaningful impact on the time series data 408. The holiday effect modeling 414 can determine whether the difference between the time series data 408 and the deholidayed series data meets or exceeds a threshold. The threshold can be based on a comparison of variation in the time series data 408 over a period of time, such as over year to year. For each holiday the holiday effect modeling 414 determines to be significant, the holiday effect modeling 414 takes the series of its holiday effects over time for each holiday separately and performs loss smoothing. The holiday effect modeling 414 further can be configured to further perform a double exponential smoothing on the smoothed holiday effects to generate forecasted holiday effects for future holidays.

The training stage 404 can include a seasonal and trend decomposition using local regression (STL) module 418 to generate a de-seasoned component 420 and a seasonal component 422 of the preprocessed time series. The STL module 418 can estimate nonlinear relationships and decompose a time series into multiple components, such as the trend component, seasonal component, and/or remainder component. The de-seasoned component 420 can be processed via a Kwiatkowski-Phillips-Schmidt-Shin (KPSS) test module to generate a plurality of ARIMA models 424. The seasonal component 422 can be provided to a double exponential smoothing module 426.

In the forecasting stage 406, the de-seasoned components 420 from the ARIMA models 424 can be forecast by a forecasting module 428 while the seasonal component 422 from the double exponential smoothing module 426 can be forecast by another forecasting module 430. The results from both forecasting modules 428, 430 can be combined to create forecasting results 432. The forecasting results 432 can be provided to a user device as a query response. The pipeline 400 can replicate the stages 402, 404, 406 for each input time series 408 such that each input time series 408 can be forecast in parallel.

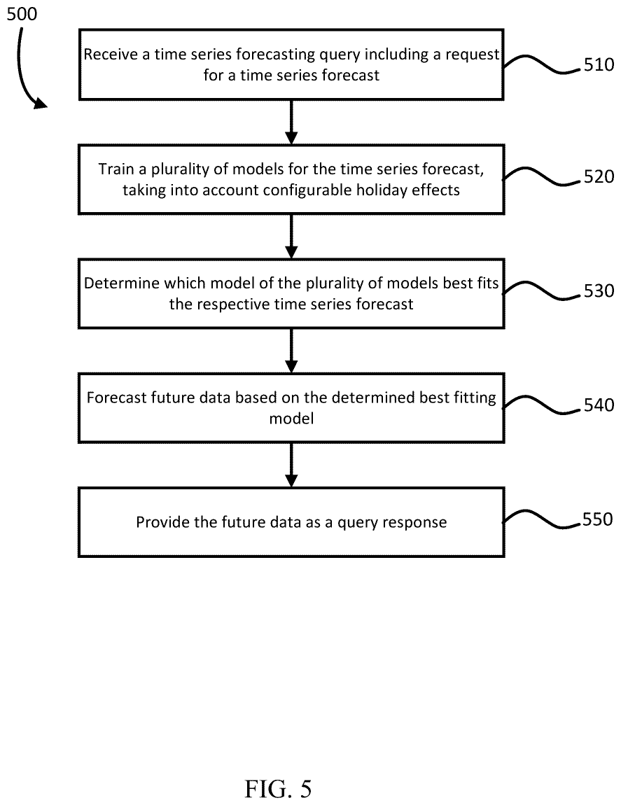

FIG. 5 depicts a flow diagram of an example process 500 for performing time series forecasting. The example process 500 can be performed on a system of one or more processors in one or more locations, such as the time series forecasting system 100 as depicted in FIG. 1.

As shown in block 510, the time series forecasting system 100 can receive a time series forecasting query that requests performance of one or more time series forecasts. Each time series forecast can be a forecast of future data based on respective current data that incorporates configurable holiday effects.

As shown in block 520, for each time series forecast of the plurality of time series forecasts, the time series forecasting system 100 can train a plurality of models for the respective time series forecast of the plurality of time series forecasts. The time series forecasting system 100 can generate and train a plurality of ARIMA models. The time series forecasting system 100 can train the models to incorporate configurable holiday effects when forecasting. Incorporating the configurable holiday effects can include determining whether a configurable holiday is significant based on a difference between deholidayed time series data and the time series data itself. Incorporating the configurable holiday effects can further include performing smoothing on data for holidays determined to be significant.

As shown in block 530, the time series forecasting system 100 can determine which model of the plurality of models best fits the respective time series forecast of the plurality of time series forecasts. The time series forecasting system 100 can determine which model results in the lowest AIC.

As shown in block 540, the time series forecasting system 100 can forecast future data based on the determined best fitting model and respective current time series data that accounts for effects of configurable holidays. The time series forecasting system 100 can verify the forecast using a public table or table valued function.

As shown in block 550, the time series forecasting system 100 can provide the future data as a query response, such as for display as a plot on a user device.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for time series forecasting comprising:
receiving, with one or more processors, a request to perform a forecast on time series data, the time series data comprising data associated with configurable holiday information;
generating, with the one or more processors, deholidayed series data from the time series data;
determining, with the one or more processors, one or more holiday effects for the data associated with the configurable holiday information based on a difference between the deholidayed series data and the time series data;
generating, with the one or more processors, one or more models for performing the forecast based on the holiday effects; and
performing, with the one or more processors, the forecast on the time series data using the one or more models.

2. The method of claim 1, wherein configurable holiday information comprises at least one of unique holidays or holidays specific to one or more regions.

3. The method of claim 1, further comprising verifying, with the one or more processors, the forecast using a public table or table valued function.

4. The method of claim 1, wherein generating the one or more models further comprises training the one or more models to account for the holiday effects when performing forecasts.

5. The method of claim 1, wherein generating the one or more models further comprises selecting a model of the one or more models to perform the forecast.

6. The method of claim 1, wherein generating the deholidayed series data further comprises setting days in a holiday impact window as missing values in the time series data.

7. The method of claim 6, wherein the holiday impact window comprises a day before a holiday, one or more days of a holiday, and a day after the holiday.

8. The method of claim 6, wherein generating the deholidayed series data further comprises employing loss interpolation on the missing values in the time series data.

9. The method of claim 6, wherein determining one or more holiday effects further comprises determining, for each holiday impact window in the time series data, whether a difference between the deholidayed series data and the time series data is greater than a threshold.

10. The method of claim 9, wherein determining one or more holiday effects further comprises performing at least one of loss smoothing or double exponential smoothing for each holiday impact window where the difference between the deholidayed series data and the time series data is greater than the threshold.

11. A system comprising:
one or more processors; and
one or more storage devices coupled to the one or more processors and storing instructions that, when executed by the one or more processors, cause the one or more processors to perform operations for a method for time series forecasting, the operations comprising:
receiving a request to perform a forecast on time series data, the time series data comprising data associated with configurable holiday information;
generating deholidayed series data from the time series data;
determining one or more holiday effects for the data associated with the configurable holiday information based on a difference between the deholidayed series data and the time series data;
generating one or more models for performing the forecast based on the holiday effects; and
performing the forecast on the time series data using the one or more models.

12. The system of claim 11, wherein the operations further comprise verifying the forecast using a public table or table valued function.

13. The system of claim 11, wherein generating the one or more models further comprises training the one or more models to account for the holiday effects when performing forecasts.

14. The system of claim 11, wherein generating the one or more models further comprises selecting a model of the one or more models to perform the forecast.

15. The system of claim 11, wherein generating the deholidayed series data further comprises setting days in a holiday impact window as missing values in the time series data.

16. The system of claim 15, wherein the holiday impact window comprises a day before a holiday, one or more days of a holiday, and a day after the holiday.

17. The system of claim 15, wherein generating the deholidayed series data further comprises employing loss interpolation on the missing values in the time series data.

18. The system of claim 15, wherein determining one or more holiday effects further comprises determining, for each holiday impact window in the time series data, whether a difference between the deholidayed series data and the time series data is greater than a threshold.

19. The system of claim 18, wherein determining one or more holiday effects further comprises performing at least one of loss smoothing or double exponential smoothing for each holiday impact window where the difference between the deholidayed series data and the time series data is greater than the threshold.

20. A non-transitory computer readable medium for storing instructions that, when executed by one or more processors, cause the one or more processors to perform operations for a method for time series forecasting, the operations comprising:
receiving a request to perform a forecast on time series data, the time series data comprising data associated with configurable holiday information;
generating deholidayed series data from the time series data;
determining one or more holiday effects for the data associated with the configurable holiday information based on a difference between the deholidayed series data and the time series data;
generating one or more models for performing the forecast based on the holiday effects; and
performing the forecast on the time series data using the one or more models.
